(19) United States
(12) Patent Application Publication
(10) Pub. No.: US 2026/0078003 A1
(43) Pub. Date: Mar. 19, 2026

(54) METHOD FOR THE SYNTHESIS OF GALLIUM NITRIDE WITH N2 NEAR ROOM TEMPERATURE

(71) Applicant: THE REGENTS OF THE UNIVERSITY OF CALIFORNIA, Oakland, CA (US)

(72) Inventors: Zakaria Y. Al Balushi, Oakland, CA (US); Sara Christy Susanto, Bloomfield Hills, MI (US)

(21) Appl. No.: 19/108,702

(22) PCT Filed: Aug. 31, 2023
(86) PCT No.: PCT/US2023/073226

§ 371 Date: Mar. 4, 2025

Related U.S. Application Data
(60) Provisional application No. 63/403,915, filed on Sep. 6, 2022.

(51) Int. Cl. C01B 21/06

(52) U.S. Cl. CPC C01B 21/0632; C01P 2002/85; C01P 2002/90

(57) ABSTRACT

A method of synthesizing gallium nitride includes mixing a rare-earth element into melted gallium to create a solution, bubbling earth abundant nitrogen (N₂) into the solution to produce gallium nitride (GaN). A method of dissociating earth abundant nitrogen (N₂) includes providing a solution that contains a rare-earth element, and bubbling earth abundant nitrogen through the solution to produce atomic nitrogen (N).

### RELATED APPLICATION

This application claims priority to and the benefit of U.S. Provisional Application No. 63/403,915 filed Sep. 6, 2022, which is incorporated herein by reference in its entirety.

### TECHNICAL FIELD

This disclosure relates to a method of synthesizing gallium nitride, more particularly to synthesize gallium nitride near room temperature from liquid gallium with nitrogen gas dissociated with rare-earth elements in pure and/or oxide forms.

### BACKGROUND

Gallium nitride (GaN) has been researched as a breakthrough material in recent years due to its large bandgap (˜3.4 eV at 298 K) and electronic properties. For example, power devices and high-frequency electronics use GaN in its thin film form due to its high breakdown voltage and high electron mobility. Currently, thin film growth of GaN is hindered by the lack of suitable substrates for GaN deposition by metal-organic chemical vapor deposition (MOCVD) and molecular beam epitaxy (MBE). Substrates used in thin film growth of GaN include silicon, sapphire, and silicon carbide. These substrates limit the quality of grown GaN due to high mismatches between the lattice and coefficient of thermal expansion, resulting in thin films with increased defect densities. Bulk GaN is used as a substrate for the growth of high-quality single crystal thin films of GaN and other group-III nitrides grown by MOCVD and MBE. The growth of bulk GaN substrates has not come to its full commercial realization due to the high cost of production.

A few methods for bulk growth of GaN are worth noting. These growth processes include a sodium flux method, ammonothermal processes, and high pressure nitridation. The sodium flux method involves the heating of a sodium-gallium melt at 850° C. in an N₂ environment with pressures ranging between 1 and 10 MPa. In the ammonothermal process, ammonia serves as the source for nitridation in the formation of GaN. The process uses supercritical ammonia (ammonia held above its critical temperature/pressure) at 380° C. and 270 MPa to grow GaN. The high-pressure method can utilize earth abundant nitrogen gas (N₂) without the addition of catalysts. However, these processes share a commonality of high energy requirement for the synthesis process of bulk nitride materials. These processes are energy intensive due to the difficulties in dissociating the triple bond of N₂ into atomic nitrogen for the synthesis of nitride materials such as GaN, as the dissociation energy of N₂ is in the range of 945 kJ mol⁻¹. Using N₂ gas as the nitrogen source for GaN growth will always need high temperature and/or pressure. Therefore, it is imperative to develop alternative synthesis processes to reduce the energy requirements for the growth of bulk GaN, in single/polycrystalline-to-amorphous forms, so that it may be more readily available for a variety of applications, including, but not limited to electronic and optoelectronic devices but also catalysts for water splitting and the production of fuels of high value, hard coatings for radiation hardness and heat dissipation as well as precursors for the synthesis of nitride thin films and nanostructures and beyond.

### BRIEF DESCRIPTION OF THE DRAWINGS

FIG. 1 shows a flowchart of an embodiment of a method of synthesizing gallium nitride.

FIG. 2 shows XPS spectra for C Is core levels for two samples.

FIG. 3 shows XPS spectra for Ga 2p3 core levels for two samples.

FIG. 4 shows XPS spectra for N 1s5 core levels for two samples.

FIG. 5 shows RBS spectrum of a sample.

### DETAILED DESCRIPTION OF THE EMBODIMENTS

The embodiments here provide a method of synthesizing gallium nitride near room temperature. Further, the embodiments provide a method of dissociating nitrogen from N₂ to atomic (N) nitrogen near room temperature and ambient pressure using rare-earth elements with and without surface oxides dissolved in liquid metals.

As used here, the term “earth abundant nitrogen” refers to N₂ that normally takes the form of a gas, so the discussion may also refer to N₂ as “nitrogen gas.” The term “atomic nitrogen” refers to a single atom form of nitrogen, or N, which may also be in gaseous form, but will not be referred to as nitrogen gas. The “lanthanide” series of chemical elements generally comprises the 15 metallic chemical elements with atomic numbers 57-71, from lanthanum through lutetium. The group includes lanthanum, cerium, praseodymium, neodymium, promethium, samarium, europium, gadolinium, terbium, dysprosium, holmium, erbium, thulium, and ytterbium. These elements, sometimes along with the elements scandium, atomic number 21, and yttrium, atomic number 39, are typically referred to as the rare-earth metals, minerals, or elements. This discussion will refer to this group as “rare-earth” elements.

Rare-earth nitrides have been found to be much easier to synthesize at lower temperatures using nitrogen gas as the nitridation source. Deposition of ultra-high purity lanthanide films by MBE (molecular beam epitaxy) has shown to produce lanthanide nitrides when exposed to N₂ gas at 30° C. and 1×10⁻⁴ torr reactor pressure. Therefore, rare-earth elements could aid in the dissociation of N₂. To determine the likelihood of forming GaN in the presence of rare-earth elements, a rough estimation of Gibbs free energy was performed for both GaN and gadolinium nitride (GdN) at 30° C. using values of entropy and enthalpy found from literature.

The inventors found that the approximate values for the Gibbs free energy of GaN and GdN at 30° C. were −98.258 kJ/mol and −369.5 kJ/mol, respectively. Despite GdN having a much lower Gibbs free energy than GaN, it is expected that both compounds could be formed at 30° C. if N₂ can dissociate into atomic nitrogen. The embodiments demonstrate the use of rare-earth elements, specifically gadolinium, to assist in the dissociation of N₂ to atomic nitrogen and serve as a source for the synthesis of GaN directly in liquid gallium at room temperature for the first time. The surface oxide on gadolinium may further assist in the activation of N₂, which the inventors corroborated from quantum mechanics molecular dynamic simulations.

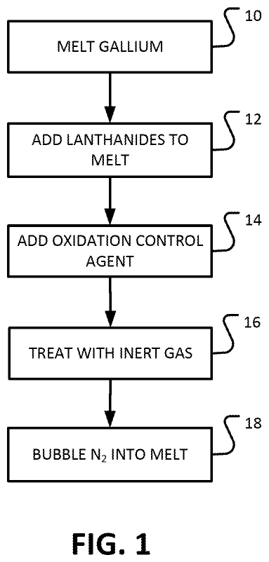

FIG. 1 shows an embodiment of a process to synthesize GaN at room temperature and ambient pressure. The process initially starts at 10 with melting gallium to create a metal melt. Gallium melts between 29° C. and 30° C., so just slightly warmer than the typical measure of room temperature at 25° C. The process then dissolves a rare-earth element material in the form of powders, such as gadolinium, into the metal melt. In one embodiment, the process uses a bubbler to dissolve the powders at 12. The example below uses gadolinium, but other rare-earth elements may work. Some level of surface oxide is expected on the surface of these rare-earth element powders.

The gallium and rare-earth powders may require the addition of further materials to proactively control oxidation of the metal surface in the bubbler during the process. In the embodiment of FIG. 1, the addition of an oxidation control agent such as dilute hydrogen chloride (HCl) or hydrogen fluoride (HF) at 14 can prevent or control oxidation of the metal during the process. In addition, protons from these oxidation control agents can also assist in the activation of N₂ when combined with the rare-earth elements, which was corroborated by the inventors using quantum mechanical molecular dynamic simulations.

To ensure better mixing, the metal melt and oxidation control agent solution undergoes bubbling with an inert gas at 16. One embodiment uses argon, but other noble gases would work, including helium, xenon, neon, and krypton. After the bubbling of the inert gas, the process introduces nitrogen into the metal melt. As will be discussed in more detail below, a first sample resulted from bubbling nitrogen for one hour, and a second sample resulted from bubbling nitrogen for six hours, but any time period in that range, inclusive may be used.

### Example 1

To synthesize GaN at low temperatures with N₂ gas, gadolinium (Gd) powder was first dissolved into a liquid gallium melt in a quartz bubbler. 500 mg of gadolinium powder (99.9% purity, Alfa Aesar) was placed into a container containing 50 g of gallium metal (99.9% purity, Sigma Aldrich) inside a glove box. The bubbler containing the liquid metal was then moved outside of the glovebox.

The bubbler also contained a dilute solution of hydrogen chloride (HCl) to prevent the oxidation of gallium during the synthesis process. 100 mL of 0.1 M HCl solution was made in a fume hood using 0.8 mL of stock solution of 12 M HCl and 99.2 mL of deionized (DI) water. Using a plastic syringe. 10 mL of 0.1 M HCl was added to the bubbler.

After being placed in the water bath (30° C.) for approximately 90 minutes, the metal was liquid, and the container was agitated slightly to better incorporate the gadolinium powder. Prior to bubbling the liquid metal with N₂, inert argon (Ar) gas was first bubbled through the liquid metal and dilute HCl solution to aid in the uniform mixing of the Gd into the liquid gallium. After the control bubbling experiments with argon gas, N₂ was then introduced into the bubbler and liquid metal. The nitrogen was bubbled into the melt for one hour.

### Example 2

Example 2 follows the same process as Example 1, except the nitrogen bubbled into the melt for six hours.

Samples from each experiment were obtained by extracting material from the solidified melt. Solidified samples were then investigated through a variety of characterization techniques. The following sections discuss relevant results from selected samples.

To analyze the incorporation of nitrogen into the solidified bulk metal crystals, energy dispersive x-ray spectroscopy (EDS) was performed using Thermo Scientific™ Scios™ 2 DualBeam™. The below table shows a breakdown of the EDS estimated weigh percentages of each element present at the surface of samples produced after one-hour of bubbling in N₂.

| | Sample 1 (1 hour) | Sample 2 (6 hours) |
|---|---|---|
| Element | % | % |
| Ga | 35 | 80 |
| N | 4 | 6 |
| O | 51 | 12 |
| Cl | 9 | 1 |
| Gd | — | — |
| C | — | — |

Although each sample had very low concentrations of nitrogen, this may result from the detection limitation of EDS specifically in detecting low atomic number (Z) elements. Furthermore, oxygen was detected in all samples. Gallium often readily reacts with oxygen to form gallium oxide, a likely source of oxygen content in all samples. The result obtained from the EDS analysis of the samples provided the first indications of the possibility of atomic nitrogen incorporation into the solidified liquid metal matrix due to the presence of Gd dissolved in liquid gallium. However, the nature of bonding and amounts of nitrogen that incorporated in the samples could not be deduced from EDS alone.

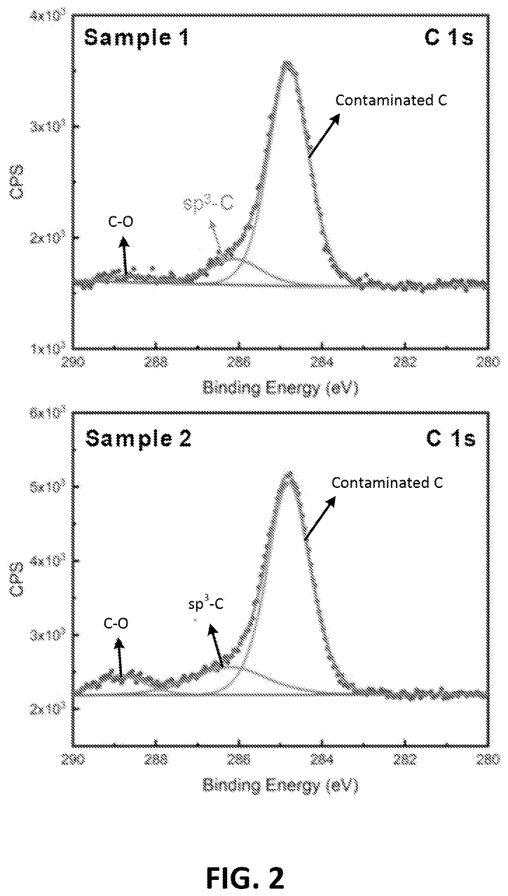

Due to atomic nitrogen having a low atomic weight, it was difficult for EDS to detect accurately the amount of nitrogen present in the samples. Therefore, a Kratos Axis Ultra XPS system with Al Kα excitation performed x-ray photoelectron spectroscopy (XPS) on the samples. The fitting of XPS data was conducted using CasaXPS. Charge correction was performed using C 1s of the adventitious carbon on the sample and elemental analysis was confirmed using CasaXPS Element Table. FIG. 2 shows the curves for C 1s. Background calibration was performed using the Shirley background approximation. When processing the core-levels, Auger signals were ignored (such as Ga LMM). Notable features of interest for the core-levels were core-level shift and core-level location.

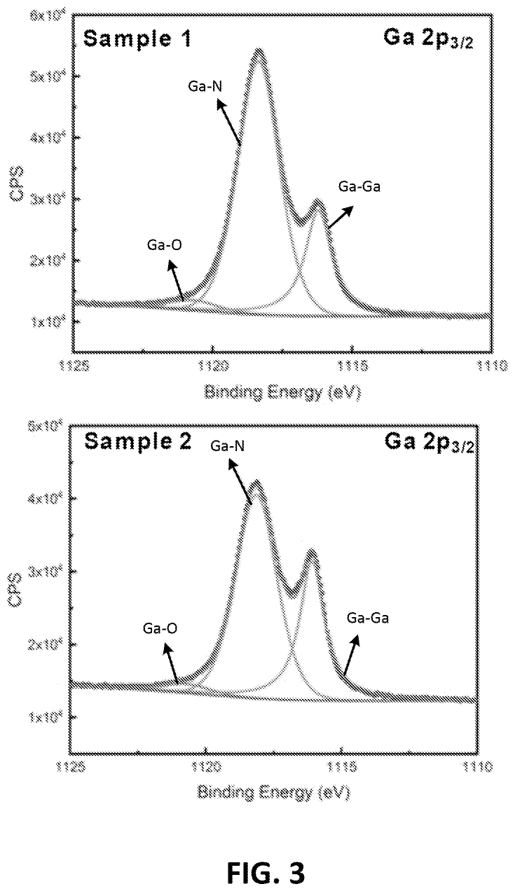

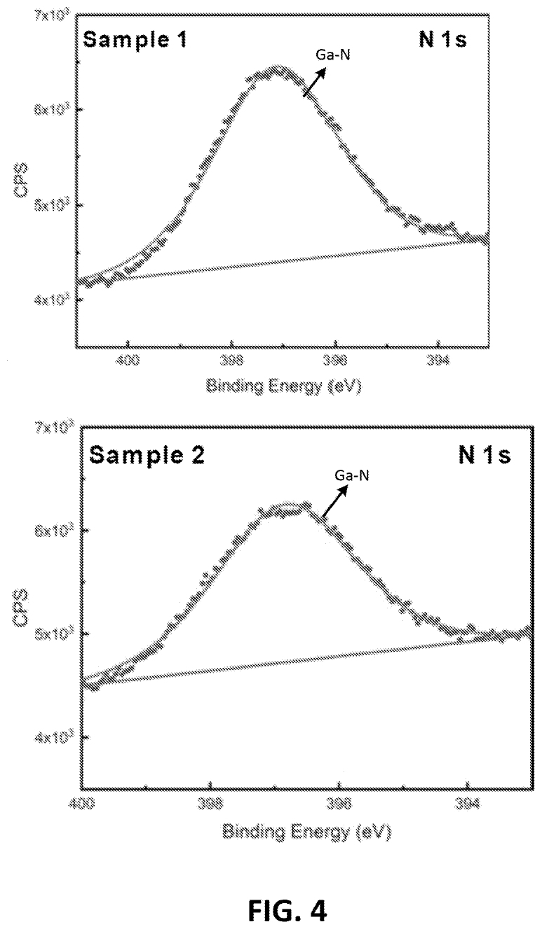

As seen in FIGS. 3 and 4 showing the analysis of two core-levels, the gallium (Ga) 2p3 core-level and the nitrogen (N) 1s5 core-level, detected nitrogen. The locations of the XPS core-levels were noted to determine the nature of the bonding between Ga and N. The XPS core-level locations were compared to literature values of pure Ga as well as GaN. As seen in the locations of the gallium (Ga) 2p3 core-level for each sample was shifted upwards from the values of pure Ga 2p3. The Ga 2p3 core level location was therefore indicative of the gallium bonding state to be in the Ga³⁺ and not Ga⁰ as it would for pure Ga. The deviation from the National Institute for Standards and Technology (NIST) GaN Ga 2p3 position and the experimental values may be due to the presence of impurities in the samples.

Based on the EDS results, there was likely oxygen and chlorine also incorporated into the samples and potentially bonded with gallium. Contaminants, such as gallium oxide and gallium oxynitrides, can play a role in the shifting of Ga 2p3 core-level locations as defects and impurities can affect XPS core-level positions due to the potential formation of other Ga bonding states. From the analysis of the N 1s5 core-level for the samples shown in FIG. 3, the positions of the core-levels were in the range for GaN when referenced to positions obtained from the NIST database. The observed deviation could be due to impurities in the samples, such as gallium oxynitrides or other nitrogen compounds in the system. It is difficult to state with certainty which impurities or compounds may be affecting the results, but the relative locations of the Ga 2p3 core-level and the N 1s5 core-level were in alignment with literature values for GaN. In addition to confirming the presence of nitrogen, the XPS spectra had indicated that the bonding state of gallium was likely to be with nitrogen in GaN.

Rutherford backscattering spectroscopy (RBS) was performed to analyze nitrogen in the samples in greater detail. The nitrogen signal in RBS spectra can be increased significantly by using resonant beam energies that lead to non-Rutherford cross sections for nitrogen, which allows for the robust determination of nitrogen concentration in samples. This technique is regularly used in this configuration to measure the nitrogen concentration in a range of thin film nitride materials on oxide substrates, where under normal RBS conditions the nitrogen signal would be undetectable due to the thinness of the film and the oxygen background in the spectrum from the substrate. For the RBS spectra taken for this experiment: the beam had a 2 mm diameter, the beam consisted of 9.0 MeV He²⁺ ions, and the data was collected at a scattering angle of 165 degrees. The beam energy and scattering angle were selected to obtain a non-Rutherford scattering cross section for N that is approximately 70 times larger than its Rutherford scattering cross section, which helps to improve the detection of the amount of N in the sample.

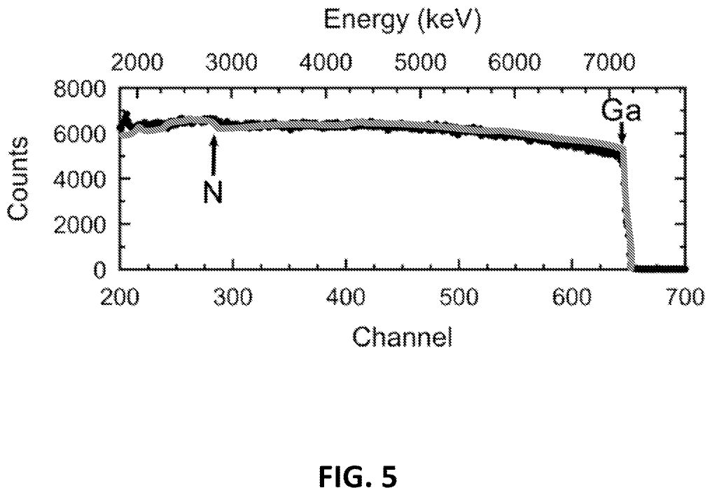

The sample of GaN was run for 4×10⁶ counts, and a spectrum of a Si sample was taken before starting the runs to calibrate the yields and energies of the spectra. The spectrum was fitted using the program SIMNRA, to obtain the concentrations of Ga and N in the sample. The compositions resulting from the fit showed a gallium concentration of 0.968±0.001 and a nitrogen concentration of 0.032±0.001 and the fitted spectrum is shown in FIG. 5. While the nitrogen signal in the RBS spectrum of the GaN sample is relatively small, the inventors took 4 million counts in total for the spectrum to ensure that the peak is statistically significant and not noise. Additionally, theoretical simulations of the spectrum for the experimental set-up agree with the overall spectrum obtained, as well as the shape and location of the signal for each element within the spectrum. This all gives a high degree of confidence in the elemental concentrations determined by RBS for the GaN sample.

While the form of the GaN produced was ultimately in the bulk, thin film forms of GaN (and related nitrides) could be realized under similar conditions. While the above processes focused on the use of gallium for GaN, no limitation exists to just gallium. Other metals could undergo the same process to produce indium nitride (InN), aluminum nitride (AlN), tin nitride (SnN), among many others. The combination of rare-earth and liquid metal, when bubbled with the earth abundant nitrogen, produces a metal nitride compound, of which gallium nitride provides one example. The liquid metal used in the process may comprise one of the post-transition metals, sometimes referred to as “other” or “poor” metals, which include aluminum, gallium, indium, tin, bismuth, and other low melting point elements that may form nitride materials when reacted with atomic nitrogen in the process. This discussion uses the term “low melting point elements” to refer to elements with a melting point of less than or equal to 300° C.

The dissociation of N₂ at low temperatures and ambient pressures could be instrumental in the production of nitrogen containing chemicals such as ammonia. Currently, ammonia processes involve high temperatures and pressures that increase the energy expense of the synthesis. Given that N₂ can be used as atomic nitrogen at room temperature, there is a possibility that ammonia synthesis techniques can evolve to be performed with low energy requirements. Using a rare earth or lanthanide element in a solution through which N₂ bubbles to dissociate the N₂ into atomic nitrogen (N) has huge applications throughout several different industries. This results in a method that includes only the lanthanide element in solution undergoing the N₂ bubbling to produce atomic nitrogen. The bubbling process may occur similar to that in the above process, where the bubbling occurs for a time period between one and six hours.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art that are also intended to be encompassed by the embodiments.

What is claimed is:

1. A method of synthesizing gallium nitride, comprising:
mixing a rare-earth element into a melted metal to create a solution; and
bubbling earth abundant (N₂) into the solution to produce a metal nitride compound.

2. The method as claimed in claim 1, wherein the metal comprises one selected from the group consisting of post-transition metals.

3. The method as claimed in claim 1, wherein the metal comprises one of gallium, indium, and tin.

4. The method as claimed in claim 1, wherein the lanthanide element comprises gadolinium.

5. The method as claimed in claim 1, further comprising adding an oxidation control agent to the solution.

6. The method as claimed in claim 4, wherein the oxidation control agent comprises one of either hydrogen chloride, or hydrogen fluoride.

7. The method as claimed in claim 4, further comprising bubbling an inert gas through the solution prior to bubbling the earth abundant nitrogen.

8. The method as claimed in claim 3, wherein the inert gas comprises argon.

9. The method as claimed in claim 1, wherein bubbling the earth abundant nitrogen comprises bubbling earth abundant nitrogen for a time period of between one and six hours.

10. A method of dissociating earth abundant nitrogen, comprising:
providing a solution that contains a rare-earth element; and
bubbling earth abundant nitrogen through the solution to produce atomic nitrogen.

11. The method as claimed in claim 10, wherein the rare-earth element comprises gadolinium.

12. The method as claimed in claim 10, wherein bubbling the earth abundant nitrogen through the solution comprises bubbling the earth abundant nitrogen through the solution for a time period of one to six hours.
